(19) United States
(12) Patent Application Publication
(10) Pub. No.: US 2009/0057089 A1
(43) Pub. Date: Mar. 5, 2009

(54) CLUTCH ASSEMBLY AND METHOD

(75) Inventors: Richard E. Finley, China Spring, TX (US); Gary N. Warren, Washington, MO (US)

Correspondence Address: HUSCH BLACKWELL SANDERS LLP, 720 OLIVE STREET, SUITE 2400, ST. LOUIS, MO, 63101, US

(73) Assignee: WARTEK LLC, Washington, MO (US)

(21) Appl. No.: 11/845,333

(22) Filed: Aug. 27, 2007

(51) Int. Cl. F16D 13/14

(52) U.S. Cl. 192/70.18

(57) ABSTRACT

A clutch assembly and method are provided. The clutch assembly includes a base plate and cover plate secured together. A pressure plate is mounted between the cover plate and base plate and is axially movable but fixed against rotation relative to the base plate. The sides of the clutch assembly are open and friction members are carried by the base plate and pressure plate and are selectively engageable with a clutch plate positioned between the base plate and cover plate.

### BACKGROUND OF THE INVENTION

Clutches are well known in the art for selectively engaging and disengaging a driven element from a driving element. Drive elements typically include motors such as internal combustion engines and electric motors. Clutches can take the form of centrifugal clutches, disk clutches, some of which can be oil bath clutches, and idler pulleys on belts being driven by drive pulleys. Typically, clutches rely on friction to effect driving of the driven element by the driving element.

In the automotive world, including cars, trucks, race cars, motorcycles, construction equipment and the like, clutches are typically used to connect a transmission or drive train elements to the motor/engine. They are typically of the clutch plate type having a pressure plate that forces engagement between a clutch plate, flywheel and pressure plate. The clutch plate is typically mounted to the transmission input shaft and the pressure plate and the flywheel are typically mounted to the crankshaft of the engine. When engaged, the engine drives the transmission through the clutch. When disengaged, the transmission is not driven by the engine.

The automotive clutch has been in existence for many decades and has changed little in that time. They have typically been made of cast and then machined components and heavy stampings requiring a significant amount of energy to go from a low angular velocity (low RPM) to a high angular velocity (high RPM). While in passenger cars, trucks and heavy equipment, such is acceptable, racing cars present different requirements. Racing cars such as dirt track cars, formula one cars, drag cars and Indy type cars, need to perform at their optimum since many races are won or lost on fractions of a second, an issue not attendant with normal cars, trucks and heavy equipment.

Clutches used in racing vehicles are subjected to much more abuse, harsher operating conditions, significantly higher forces and should be easily replaceable on site at a race track or garage. However, it would be desirable to provide a clutch assembly and method adapted for improving clutch performance and that permits repair on site and will perform under more rigorous conditions, for example, on dirt tracks where dirt has been known to adversely affect clutch performance when it gets into the clutch assembly. It would also be desirable, to eliminate the flywheel as a drive train and clutch component.

Therefore, there is a need for an improved clutch assembly that enhances clutch operation and improves the ability to repair the clutch on site.

### SUMMARY OF INVENTION

The invention involves the provision of a clutch assembly that is self contained and may be mounted to a flywheel or to the engine or motor output shaft directly while eliminating the flywheel. The clutch assembly includes a series of generally parallel positioned plates including a base plate for mounting next to the engine, a pressure plate and a cover plate with the pressure plate positioned between the base and cover plates. A series of posts are spaced around the periphery of the plates and are used to hold the cover plate and base plate in spaced relation. Mechanical fasteners are used to secure the posts in place and to the cover and base plates. The posts form openings therebetween around the outer periphery of the clutch assembly. The pressure plate is retained against rotation relative to the cover and base plates by having a plurality of peripherally spaced apart notches each having a respective post received therein. A diaphragm is provided to selectively apply force to the pressure plate to effect clutch engagement. The diaphragm is also operable to release the force to effect disengagement of the clutch disk from driving engagement. Friction material is provided and can be secured to the pressure plate and base plate with the clutch plate having a clutch disk positioned between the sets of friction material. The friction material is mechanically secured to the pressure plate and base plate in a manner to effect its easy removal and replacement. Such securement can be by mechanical fasteners, for example, threaded screws, rivets or the like. The clutch assembly can utilize a plurality of clutch plates by providing one or more intermediate friction plates with friction material thereon. The clutch assembly may also be provided with a ring gear to effect starting of an internal combustion engine.

The present invention also involves the provision of a method of operating a clutch assembly. The method includes having a clutch assembly mounted to a driving element with a portion mounted to a driven element. After use, and upon scheduled maintenance or clutch malperformance, the driven element may be disengaged from the clutch assembly, the clutch assembly disassembled on site and the non-functioning part or parts replaced or repaired on site. In particular, the friction members may be easily replaced by removing the mechanical fasteners and installing new friction members with mechanical fasteners. No resurfacing of a flywheel or pressure plate is needed.

### BRIEF DESCRIPTION OF DRAWINGS

FIG. 1 is a side elevation view of one form of clutch assembly.

FIG. 2 is an exploded fragmentary view of the clutch assembly showing the clutch assembly without an optional ring gear.

FIG. 3 is an end view of the clutch assembly FIG. 1 shown from the base plate.

FIG. 4 is an end view of the clutch as seen from the cover plate.

FIG. 5 is an end view of the friction side of the pressure plate.

FIG. 6 is a fragmentary sectional view of the clutch of FIGS. 1 and 2.

FIG. 7 is a fragmentary sectional view of a clutch showing a multiple clutch disk clutch assembly.

FIG. 8 is an exploded view of a clutch assembly similar to that of FIG. 2 but including an optional ring gear.

Like numbers throughout the various figures designate like or similar parts and/or construction as described herein.

### DETAILED DESCRIPTION

The reference numeral 1 designates generally a clutch assembly. The clutch assembly 1 includes a cover 3, base 4 secured in spaced relationship and having positioned therebetween a pressure plate 5, clutch plate 6 and at least two friction members 7, 8 with at least one friction member positioned on each of the opposite sides of the clutch plate 6. Also provided is a force applicator in the form of a diaphragm 10 that is configured to selectively apply force to the pressure plate 5 and to urge engagement between the friction members 7, 8 and the clutch plate 6 to effect engagement and disengagement of the clutch.

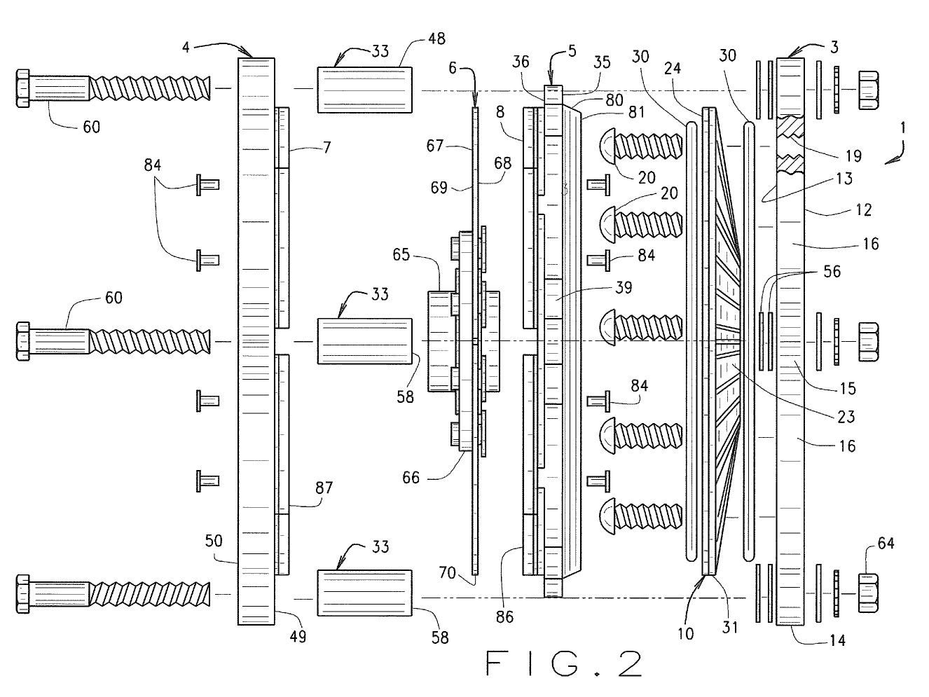

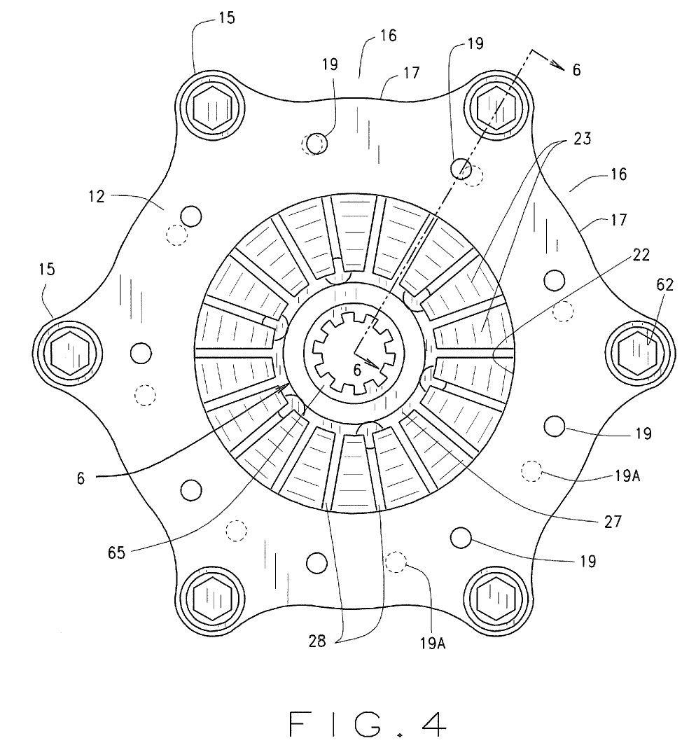

The cover 3 is in the form of a generally planar plate having opposite sides 12, 13 with the side 12 facing outwardly and the side 13 facing inwardly into the clutch assembly (FIGS. 2, 4). Preferably the sides 12, 13 are generally planar and parallel. In the illustrated structure, the cover 3 has a plurality of peripherally spaced apart radially outwardly extending ears 15. Extending between adjacent ears 15 is a recess 16 having a bottom or nadir zone 17. The cover 3 may be provided with plurality of spaced apart apertures 19 to help effect securement of the diaphragm 10 thereto. As shown, the diaphragm 10 is secured in place by fasteners 20 such as screws received in threaded apertures 19. A plurality of aperture patterns may be provided to accommodate different diaphragms. One pattern of apertures is shown in solid lines while an alternative pattern of apertures 19A is shown in broken lines for clarity. Diaphragms 10 can be provided in different designs or operating force or brands while the cover 3 can accommodate one or more types of diaphragms allowing a reduced part inventory to make a clutch assembly. As shown, the cover 3 has a central through opening 22 to allow a throwout bearing to engage fingers 23 of the diaphragm 10 as is known in the art. The throwout bearing (not shown) is used to disengage the clutch plate 6 from driving engagement with the friction members 7, 8 by moving an outer ring 24 of the diaphragm toward the cover 3 to reduced force or eliminate the force applied to the pressure plate 5. In the illustrated diaphragm 10, the fingers 23 and ring 24 pivot on the fasteners 20. The cover 3 may be simply machined by a CNC machine from a material preferably having a density less than 0.15 lb/in³ and a thermal conductivity of at least about 50 BTU/hr-ft-° F. A suitable material is 6061 aircraft grade aluminum alloy.

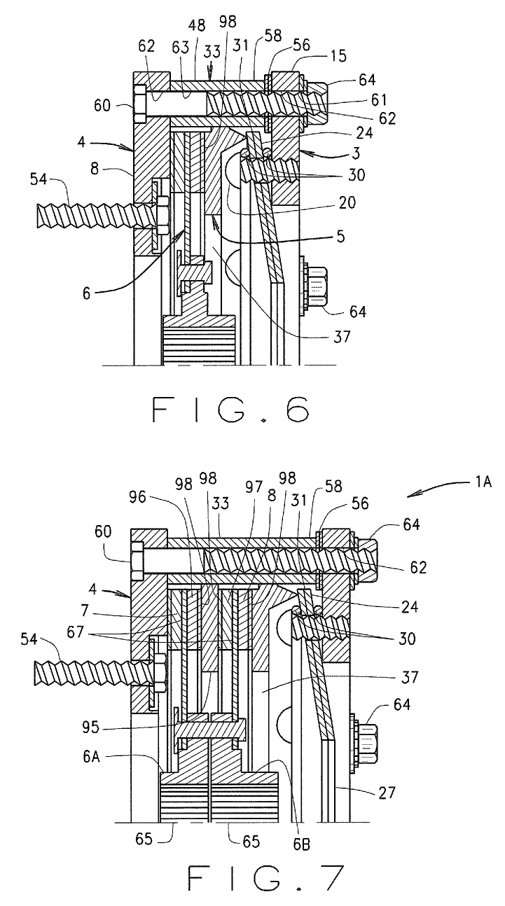

In the illustrated structure, the diaphragm 10 is a multi-fingered diaphragm having a plurality of radially projecting fingers 23 surrounding a through opening 27 (FIG. 4). The opening 27 can accommodate receipt of the transmission input shaft (not shown) therethrough for ultimate connection to the clutch plate 6. The fingers 23 have gaps 28 therebetween and are connected to and preferably integral with the outer ring 24. The fingers 23 and ring 24 pivot about the fasteners 20 preferably about annular fulcrum rings 30 (FIG. 6). The rings 30 may be an integral part of the diaphragm 10 or may be secured in place with the fasteners 20 or may be secured to the diaphragm 10 in any suitable manner. The outer edge 31 of the diaphragm is spaced radially inwardly from posts 33 and positioned between the cover 3 and base 4 (FIG. 2).

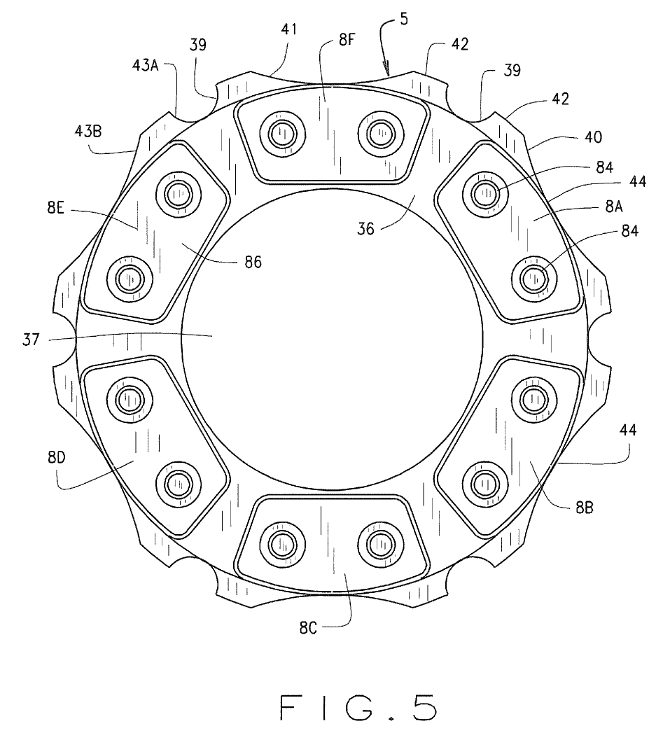

A pressure plate 5 is positioned for selective engagement with the diaphragm 10 and have the clutch plate 6 positioned between the pressure plate 5 and the base plate 4 (FIG. 2). The pressure plate 5 has opposite faces 35, 36 with the face 35 facing toward to the cover 3 and the face 36 facing toward the base plate 5. In the illustrated structure, the pressure plate 5 has a central through opening 37 (FIGS. 6, 7) to accommodate the input shaft (not shown) of the transmission for piloted engagement with the crank shaft or output shaft of the driving element, e.g., motor (not shown). The pressure plate 5 floats between the cover 3 and base 4 and is held against rotation relative to the base plate 4 and cover 3 in a suitable manner. As shown, the pressure plate 5 has a plurality of peripherally spaced outwardly opening notches 39 with each receiving a respective post 33 therein fixing the pressure plate against relative rotation and transverse or lateral movement within the clutch assembly 1 while permitting free axial movement (FIG. 5). The outer periphery 40 of the pressure plate 5 may have recesses 41 therein with bottom or nadir zones 44. The nadir zones 44 are preferably positioned radially inwardly of the inside edges of posts 33. As shown, the notches 39 are formed by outwardly projecting ears 42, one on each side of the respective notch 39. The cross sectional area size of the material of the ears 42 from the outside edge 43A of the notch 39 and the edge 43B of an adjacent recess 41 can be constructed to provide for a shear zone to allow shear of the pressure plate while it is restrained against radial movement by the posts 33. While the pressure plate 5 remains radially restrained, shearing can occur in the shear zones to protect the clutch from forces that could adversely affect the pressure plate and thereby reduce the possibility of pressure plate blowup from torque induced by engagement of the clutch plate 6 for driving. In a preferred embodiment, the pressure plate 5 is made from a material similar to that described for the cover plate 3. A high quality aluminum alloy has been found effective.

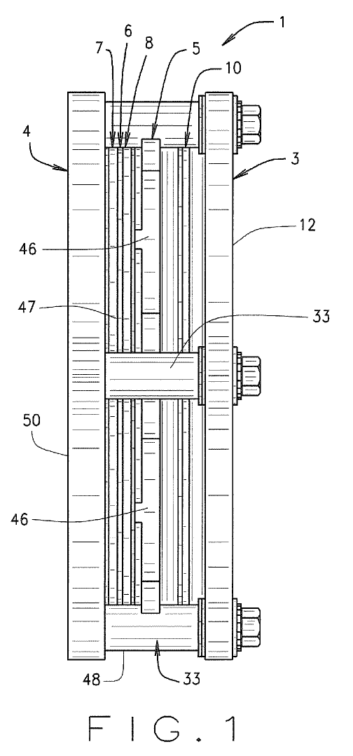

The posts 33 are spaced apart peripherally providing openings 46 therebetween. The posts 33 include a respective sleeve member 48. The size of an opening 46 is determined by the height of the post and the peripheral spacing between adjacent posts (FIG. 1). The illustrated structure provides a cage construction which allows dirt or other debris that might contaminate the clutch assembly 1 to be thrown outwardly and into the bell housing unlike the traditional stamped pressure plate housing that bolts to a flywheel. The openings 46 comprise at least a majority of the side face 47 between the cover 3 and base 4 and preferably at least about 70%. In the illustrated structure, only the posts 33 close part of the side face 47.

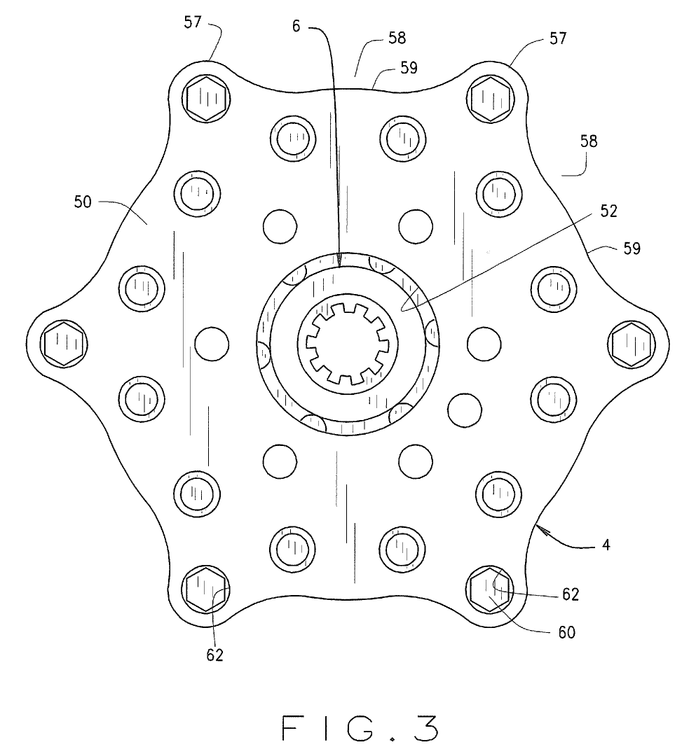

The base plate 4 has opposite faces 49, 50 with the face 49 facing the cover 3 and the face 50 facing the driving element (FIG. 2). The cover 3, base 4 and pressure plate 5 have generally centrally transverse planes that are generally parallel. There is a general centrally located opening 52 through the base plate 4 to provide access for the input shaft of the transmission for pilot and engagement with the driving element (FIG. 3). The driving element may be any suitable motor, e.g., an internal combustion engine or electric motor and has an output shaft, e.g., a crankshaft for the internal combustion engine. The base plate 4, and hence the clutch assembly 1, may be secured to the driving element as with threaded fasteners such as hex head bolts 54 (FIG. 6). Shims 56 may be provided and cooperate with the posts 33 to provide for adjustment of the spacing between the face 49 and face 13 of the cover 3 and force applied to the clutch plate 6 and to compensate for wear to the friction members 7, 8. As illustrated in FIG. 2, the shims 56 are positioned between an end 58 of the sleeves 48 and the face 13 of the cover 3. Other positions may be used for the shims 56. In the illustrated structure, the cover 3 and base 4 are secured together by the posts 33 each including a mechanical fastener such as a threaded bolt 60 extending through respective openings 62, 63 in the cover 3 and base 4 and bores 63 extending longitudinally through each of the posts 33 (FIG. 6). The apertures 62 are preferably located in the ears 57. Outwardly opening recesses 58 are provided and each has a bottom or nadir zone 59. The recesses 58 may be similar in size and shape to the recesses 16 in the cover plate 3. The bolts 60 may be any suitable bolt such an Allen head bolt or a Torx head bolt and are preferably recessed into the cover 3 and base 4 in countersunk holes 62. Fasteners such as threaded nuts 64 can be used to secure the bolts 60 in place. A sex bolt or binding bolt may also be used. Alternatively, the sleeves 48 may be internally threaded and separate fasteners used for the cover 3 and the base 4.

The clutch plate 6 is shown as having a splined hub 65 that mounts onto the driven element, e.g., the transmission input shaft (not shown) to effect rotation of the input shaft (FIGS. 2, 6). As shown, the hub 65 includes a flange 66 to which is suitably secured a clutch disk 67. The clutch disk 67 is suspended between the pressure plate 5 and base plate 4 such that when force is applied to the friction members 7, 8, the clutch assembly 1 will become engaged to effect driving of the driven element by the driving element. As shown, the disk 67 is an annular disk having opposite faces 68, 69 that are generally parallel and lie in a plane generally parallel to the transverse planes of the cover 3, pressure plate 5 and base plate 4. The outer peripheral edge 70 is positioned radially inwardly of the inside edges of the posts 33. The clutch disk 67 may be provided with thermal expansion joints (not shown) if desired. Preferably, the disk 67 is made of hard steel, for example, 1050 type of steel having hardness in the range of between about 33 and 40 Rockwell C. The hub 65 may be a machined casting. It is also preferably of a steel material.

The pressure plate 5 (FIGS. 2, 6) is shown as being positioned between the clutch disk 67 and the cover plate 3. The pressure plate 5 has a through central opening 37 which allows for access through that portion of the clutch assembly for the input shaft of the transmission as described above. The pressure plate 5 has opposite faces 35, 36 as described above. The pressure plate 5 may be provided with a fulcrum 80. As shown, the fulcrum 80 is in the form of a generally V-shaped annular rib although a segmented rib could also be used. The apex 81 engages the diaphragm 10 adjacent or on the ring 24 and on the outside of the pivot points at the fulcrum 30 (FIG. 6). When the fingers 23 move to their normal positions, force is applied to the fulcrum 80 and hence the pressure plate 5 to effect frictional engagement between the friction members 7, 8 to effect driving engagement of the clutch plate 6. Movement of the fingers 23 to a biased position, the force is reduced or eliminated allowing the clutch plate 6 to become disengaged from its driving configuration. In a preferred embodiment, the friction members 7, 8 are each suitably secured to the pressure plate 5 and the base plate 4 respectively.

In the illustrated structure, the friction member 7 and 8 contain discreet segments (7A, 7B . . . , 8A, 8B . . . ) secured to the pressure plate 5 and the base plate 4 respectively, as with mechanical fasteners 84 for example, the flathead bolts or rivets to facilitate their removal and replacement on site during either scheduled maintenance or when there is a clutch malfunction. The fasteners 84 may be in threaded engagement with one of the respective pressure plate 5 and base plate 4 for securement of the friction member 7, 8 thereto. While each of the friction rings formed by the respective friction members 7, 8 are shown as being discreet segments spaced peripherally around either the pressure plate 5 or base plate 4, it is to be understood that the friction members can be a continuous ring in annular form. Preferably, the friction members 7, 8 are made of a ceramic friction material or a metallic friction material with that being preferred over an organic friction material. A suitable friction member 7 or 8 is made from a bronze based powder BP 11555 made by SK Wellman Co. The friction members 7, 8 have opposed inside faces 86, 87 respectively that will engage opposite faces 68, 69 of the clutch disk 67 to effect driving of the clutch disk and clutch plate 6 in the form of invention shown in FIGS. 2, 6.

As best seen in FIG. 4, the cover plate 3 has a plurality of apertures 19 for receipt of the fasteners 20 therein. Typically, a diaphragm 10 has a prearranged configuration of mounting holes that may be different between various types, styles or brands of diaphragms. In a preferred embodiment, cover 3 is provided with multiple sets of apertures to provide more than one mounting pattern. An alternative mounting pattern of apertures is shown in broken lines and are designated 19A while another is shown in solid lines and designated 19. This permits using one cover plate for various diaphragms 10 and thereby reduces the parts inventory to make clutch assemblies 1.

The present invention permits the manufacture of the some of the components and in particular the cover 3, base 4 and pressure plate 5 from flat stock by simple machining methods. Machining can be accurate enough in the present invention to eliminate or reduce the need for balancing of the clutch assembly 1 after manufacture or after a repair or maintenance. The side openings 46 between the posts 33 permit discharge of dirt or other debris out of the clutch assembly to extend the operating life either between cleanings or reducing the need for repair or maintenance. The recesses 16, 58 between the ears 15, 57 respectively on the cover 3 and base 4 permit reduction in the weight and thus inertial mass and momentum of the clutch assembly 1 during operation.

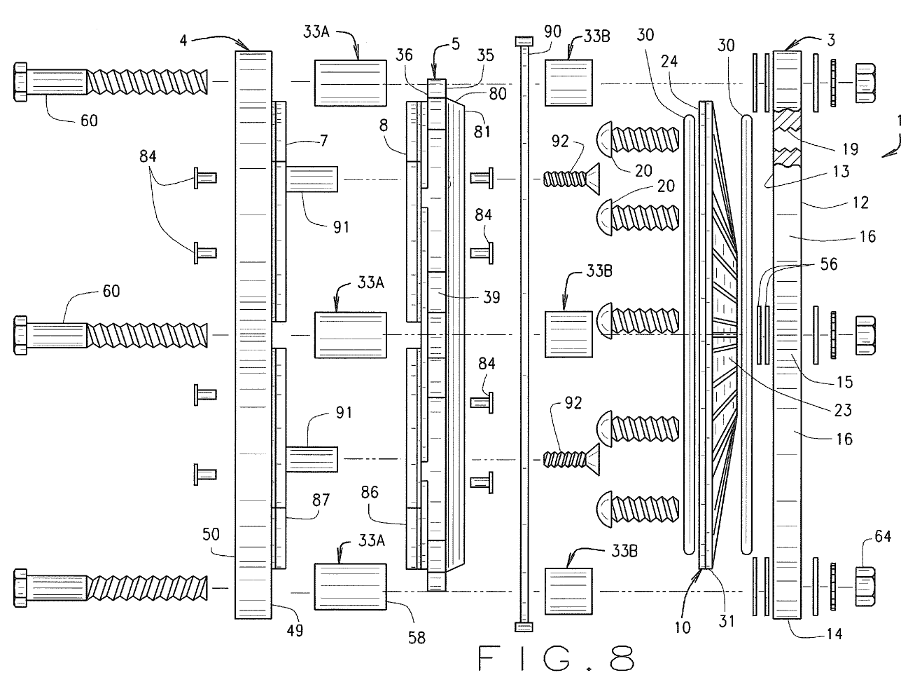

FIG. 8 shows an alternative embodiment of the present invention. In this embodiment, a ring gear 90 is shown as mounted between the cover 3 and base 4 or could be mounted thereon in this embodiment. The ring gear 90 can be used to replace the starter gear on the flywheel and thus eliminate the flywheel from the drive train. As shown, the ring gear 90 is supported and fixed against rotation relative to cover 3 and base 4 by a plurality of support stands 91 (only two being shown for clarity) secured in place with suitable fasteners 92 such as flathead screws. The ring gear is additionally fixed against rotation relative to the base 4 by having the posts 33 which include post segments 33A, 33B with fasteners 60 extending through apertures (not shown) in the ring gear.

FIG. 7 shows another alternate embodiment of the present invention. In this embodiment, the clutch assembly 1A is substantially the same as the clutch assembly 1 but has a plurality of clutch disks 67 each preferably part of a separate clutch plates 6A, 6B. An intermediate carrier plate 95 is disposed between the pressure plate 5 and base plate 4 and preferably carries friction members 96, 97 on opposite faces thereof and can be similar in construction and mounting to the friction members 7, 8 described above. As seen in FIGS. 6, 7, the friction members 7, 8, 96, 97 can have a respective backing plate 98. The carrier plate 95 can have a periphery configuration like that of the pressure plate 5 as seen in FIG. 5 and be in splined engagement with the posts 33 and free to move axially but not transversely. The friction members 7, 8, 96, 97 are preferably mounted to the pressure plate 5, base plate 4 and carrier plate 95 respectively, in a manner to prevent relative movement between the friction members and their respective plate. Multiple clutch plates can be useful in increasing the area of frictional engagement between the clutch disks 67 and the friction members 7, 8, 96, 97. The multiple clutch disks 67 can share a common hub or can be mounted to separate hubs 65.

The present invention is better understood by description of the operation of the clutch assembly 1 or 1A. The following description is applicable to both forms but only one is described for convenience. Clutch assembly 1 is mounted to a driving element and fixed against relative rotation to its output shaft, at least with regard to the cover 3 pressure plate 5 and base plate 4. The clutch assembly 1 permits relative rotation between the clutch plate 6 and the remainder of the clutch assembly 1. When a time period has elapsed to indicate a scheduled maintenance is due or repair is needed on the clutch because of failure, malfunction or poor function, the transmission or the driven element may be removed from the bell housing in the event the clutch is used on an internal combustion engine. Removal of the fasteners 64 will free the cover 3 for removal as well as the sleeves 48 and shims 56 if the shims are used. Removal of the cover 3 and attached diaphragm 10 allows for removal of the pressure plate 5. The pressure plate 5 may then be removed followed by removal of the clutch plate 6. If maintenance is needed on the friction member 8 or friction members 96, 97 in the case of a multiple disk clutch arrangement, the friction members 96, 97 and 8 may be removed or replaced by removing the mechanical fasteners holding same in place. In the event friction members 3 need to be replaced, the base plate 4 may be removed. Thus, the clutch may be rebuilt, repaired or maintained on site easily with normal tools available to mechanics. If the clutch plate 6 needs replaced it may be easily replaced by removal after removal of the pressure plate 5.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

1. An automotive clutch assembly comprising:
a base plate constructed to mount to a motor;
a cover plate secured to the base plate and spaced therefrom;
a pressure plate movably mounted between the base plate and cover plate and movable axially therebetween and fixed against transverse movement relative to the base plate;
a first friction member secured to the base plate and overlying an internal face of the base plate, said first friction member being fixed against movement relative to the base plate, said first friction member having a first exposed face;
a second friction member secured to the pressure plate and being fixed against movement relative to the pressure plate, said second friction member having a second exposed face;
a clutch plate with a disk positioned between the first and second exposed faces, said base plate being selectively rotatable relative to the clutch plate; and
a force applicator associated with the pressure plate and operable to selectively apply axial force to the pressure plate to selectively urge engagement of the first and second friction members with the clutch disk.

2. The clutch assembly of claim 1 including a pluralilty of posts positioned in peripheral spaced relation adjacent peripheral edge portions of the base plate and cover plate and fixing axial spacing between the base plate and cover plate.

3. The clutch assembly of claim 2 wherein the pressure plate having a plurality outwardly opening notches, at least some of said posts each being received in a respective said notch fixing the pressure plate against rotation relative to the base plate and cover plate while permitting axial movement of the pressure plate.

4. The clutch assembly of claim 3 wherein the posts each include a first fastener extending between the base plate and cover plate and received through a sleeve positioned between inside faces of the base plate and cover plate.

5. The clutch assembly of claim 4 wherein the force applicator including a diaphragm and a fulcrum.

6. The clutch assembly of claim 5 wherein the fulcrum being fixed to said pressure plate.

7. The clutch assembly of claim 5 wherein the fulcrum being an integral part of the pressure plate.

8. The clutch assembly of claim 3 wherein the pressure plate notches are each positioned in an outwardly projecting ear having a leg on each said of the notch, and, the pressure plate having a recess between adjacent said ears with a nadir zone spaced radially inwardly of inside edges of the posts.

9. The clutch assembly of claim 3 including at least one shim removably mounted to each of the posts.

10. The clutch assembly of claim 4 including a plurality of apertures in the cover plate sized and positioned to accommodate a plurality of different diaphragms.

11. A clutch assembly comprising:
a base plate constructed to mount to a rotary driver;
a cover plate secured to the base plate and spaced therefrom;
a pressure plate movably mounted between the base plate and cover plate for axial movement therebetween and fixed against transverse movement relative to the base plate;
a clutch plate with a clutch disk positioned between the base plate and pressure plate;
a first friction member positioned between the base plate and disk;
a second friction member positioned between the pressure plate and disk;
a force applicator associated with the pressure plate and operable to selectively apply axial force to the pressure plate to selectively urge the base plate to drive the clutch plate;
a plurality of posts positioned adjacent outer edge portions of the base plate and cover plate and positioned about a substantial portion of the pressure plate and clutch disk and forming a side face between the base plate and cover plate, said posts being secured to the cover plate and base plate releasably securing them together and being peripherally spaced apart forming a plurality of side openings between the base plate and cover plate.

12. The clutch assembly of claim 11 wherein the pressure plate being movably mounted on the posts for axial movement and fixed against rotation relative to the base plate.

13. The clutch assembly of claim 12 wherein the side openings are at least a majority of the area of the side face.

14. The clutch assembly of claim 13 wherein first friction member being secured to the base plate and fixed against movement relative thereto and the second friction member being secured to the pressure plate and fixed against movement relative thereto.

15. A method of operating an automotive clutch assembly comprising:
providing an engine with a clutch assembly mounted to an output shaft of a motor, the clutch assembly including a base plate secured to the output shaft and a cover plate secured to the base plate and further including a pressure plate mounted for axial movement between the base plate and cover and a first friction member secured to the base plate with first fasteners and a second friction member secured to the pressure plate with second fasteners;
operating the engine until one of clutch malfunction or a scheduled maintenance and then at least one of;
removing the cover member and pressure plate and removing the second friction member and replacing it with another second friction member and securing it in place with second fasteners on site; and
removing the cover member, pressure plate, and base plate and removing the first friction member and replacing it with another first friction member and securing it in place with first fasteners on site; and thereafter reassembling the clutch assembly and operating the motor.
